(19) United States
(12) Patent Application Publication
(10) Pub. No.: US 2014/0032301 A1
(43) Pub. Date: Jan. 30, 2014

(54) ADVERTISEMENT BILLING METHOD AND DEVICE

(71) Applicant: Alibaba Group Holding Limited, George Town (KY)

(72) Inventors: Zhichao Fu, Hangzhou (CN); Xuesen Zang, Hangzhou (CN); Fanggui Jia, Hangzhou (CN)

(21) Appl. No.: 13/948,509

(22) Filed: Jul. 23, 2013

(30) Foreign Application Priority Data
Jul. 26, 2012 (CN) 201210262509.4

(51) Int. Cl. G06Q 30/02

(52) U.S. Cl. CPC G06Q 30/0242
USPC 705/14.41

(57) ABSTRACT

Embodiments of the present application relate to a method for generating flow quality comparison parameters, a system for generating flow quality comparison parameters, and a computer program product for generating flow quality comparison parameters. A method for generating flow quality comparison parameters is provided. The method includes collecting click log data and transaction log data on relevant products or services advertised in off-site advertising spaces, generating off-site advertising space results data based at least in part on the click log data and the transaction log data, obtaining quality indicators of advertising flows of the corresponding off-site advertising spaces based on the off-site advertising space results data, and obtaining flow quality comparison parameters for the off-site advertising spaces based at least in part on the quality indicators of the advertising flows of the off-site advertising spaces.

### CROSS REFERENCE TO OTHER APPLICATIONS

This application claims priority to People's Republic of China Patent Application No. 201210262509.4 entitled A METHOD AND DEVICE FOR GENERATING FLOW QUALITY COMPARISON PARAMETERS AND AN ADVERTISEMENT BILLING METHOD, filed Jul. 26, 2012 which is incorporated herein by reference for all purposes.

### FIELD OF THE INVENTION

The present application relates to an advertisement billing method and device.

### BACKGROUND OF THE INVENTION

Advertising has been an important business model throughout the development of the Internet and advertising is a direct profit making model of the Internet. The Internet industry has been continually driven by Internet advertising contributing to the Internet industry's success.

Currently, advertising typically includes two modes: on-site advertising and off-site advertising. FIG. 1 is a diagram of conventional advertisements on a shopping website. The advertisers shown on the shopping website pay on-site advertising prices to the shopping website, and the shopping website places advertisements in product advertisements on the shopping website. Here, users access relevant products by clicking the product advertisements on the shopping website. FIG. 2 is a diagram of conventional advertisements off a shopping website. The advertisers shown on the shopping website pay off-site advertising prices to the shopping website. The shopping website searches for publishers and the publishers place products in product advertisements on the publishers' websites. Users access the relevant products by clicking on product advertisements on the publishers' websites.

For advertisers, on-site advertising flow can more easily achieve the advertising goal of increasing transactions. For advertisers, off-site advertising flow primarily is used to expand brand influence of their products and to grab hold of some potential customers. Actual monitoring of results has shown that return on investment (ROI) of off-site advertising flows is less than ROI of on-site advertising flows. Therefore, if off-site advertising prices are equal to on-site advertising prices, the equality of the advertising prices does not reflect actual quality differences and imbalances that exist between on-site and off-site advertising flows.

When off-site advertising prices equal on-site advertising prices, advertisers will typically use an on-site advertising flow instead of an off-site advertising flow. However, such a trend would cause an increase in on-site advertising prices along with costs increasing for advertisers. Moreover, advertisers would lose some potential customers outside of the shopping website, and the advertiser's own business will inevitably hit a bottleneck. As for publishers, since the advertisers typically do not offer the same prices to purchase the off-site advertising flow as the on-site advertising flow, the advertisers are very likely to fail to make full sales of their flows over the long run. Consequently, the advertisers lose an assurance of long-term earnings and network resources are wasted. Regarding the shopping websites, the shopping websites are capable of increasing earnings in the short run because many advertisers rush in to buy on-site advertising flows. However, given the trend of excess demand with respect to supply, on-site advertising prices are expected to rise. Ultimately, only a small portion of the advertisers will be able to bear the higher advertising expenses. Consequently, the majority of advertisers will not be able to obtain long-term earnings, and the healthy, positive development of the shopping websites is put at risk.

In order to reflect the differences and the imbalances in quality that should actually exist between on-site and off-site advertising flows, some shopping websites use manually set flow quality comparison parameters for off-site advertising spaces. The primary reference values used in the setting process are publisher's website flow, website nature, etc. The numerical values of the parameters are determined following a human assessment of the reference values. In fact, larger parameters can be set for publisher websites with larger website flows. For example, a price ratio of 80% can be set for the better-known, large-flow websites (the price ratio “80%” represents a ratio of off-site advertising prices to on-site advertising prices). A smaller price ratio can be set for a publisher site with a smaller website flow. Or, if the nature of a website, for example, a women's fashion website, is more closely correlated with the product, a higher price ratio could be set when advertising women's fashion-related products, while a lower price ratio could be set when advertising other types of products.

However, the process described above for manually setting parameters requires human intervention. In particular, the manually setting parameters process suffers from defects of subjectivity and imprecision because the process relies primarily on human perception and experience. For example, www.55bbs.com is a women's fashion website, and the website's main purpose is to publish fashion information, let women share shopping experiences, etc. If someone who did not have a profound knowledge of the website were allowed to set the flow quality comparison parameters for off-site advertising spaces directing flow from the website to the category of women's accessories on a shopping website such as Taobao, that person would inevitably fail to accurately reflect to the proper value of the website www.55bbs.com. In fact, the advertising flow quality from www.55bbs.com is high, but the parameter may be set on the low side in such a situation. Consequently, the setting of the parameter value would significantly misrepresent the quality difference and the imbalance existing between the on-site and the off-site advertising flows.

Furthermore, if all flow quality comparison parameters for off-site advertising spaces are to be set manually, the setting of the parameters require a team of experts who understand various industry conditions. The setting efforts would be costly and inefficient.

From a technical point of view, the on-site and the off-site advertising flows are types of data resources. Since the above-described conventional solution is unable to accurately and objectively differentiate between the on-site and the off-site advertising flows with respect to quality, the above solution cannot efficiently utilize and allocate these resources effectively. For example, the result of employing the above solution could be, in the course of processing the data involved in Internet advertising, that basically all on-site advertising flow resources are used while off-site advertising resources are not be fully used.

In summary, there is a need to determine how to automatically, efficiently, objectively, and accurately generate flow quality comparison parameters for off-site advertising spaces so as to accurately assess differences in quality between off-site and on-site advertising flows, and thus to promote more balanced allocations of on-site and off-site advertising flow resources and increase utilization rates of network resources.

### BRIEF DESCRIPTION OF THE DRAWINGS

Various embodiments of the invention are disclosed in the following detailed description and the accompanying drawings.

FIG. 1 is a diagram of conventional advertisements on a shopping website.

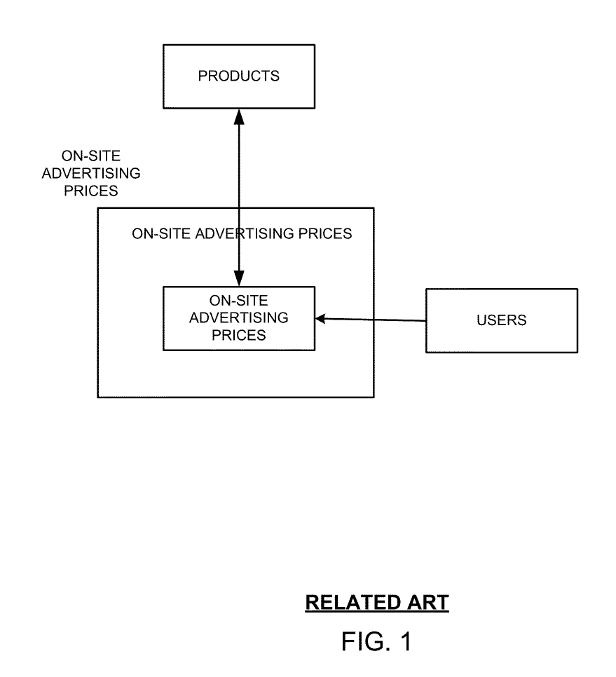

FIG. 2 is a diagram of conventional advertisements off a shopping website.

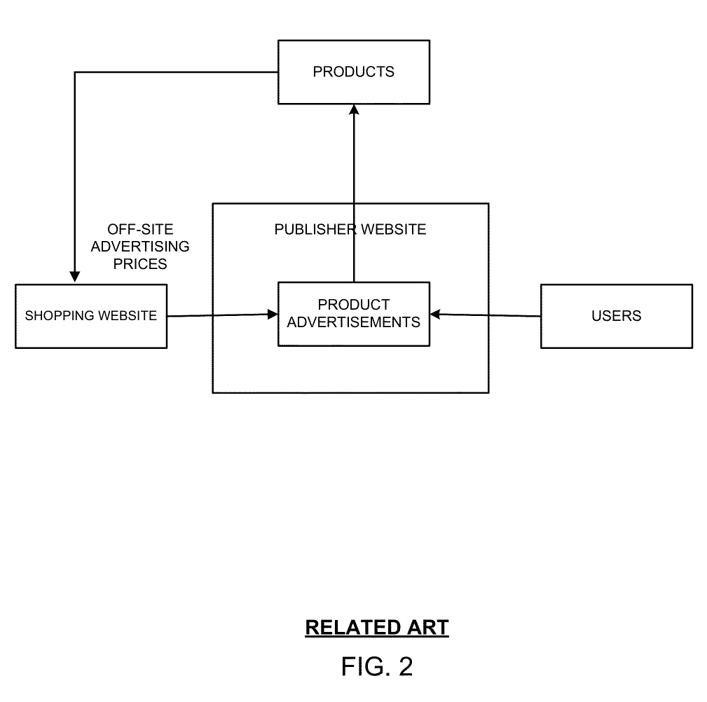

FIG. 3 is a flowchart of an embodiment of a process for generating flow quality comparison parameters.

FIG. 4 is a diagram of an embodiment of exponential decay of a weight over time.

FIG. 5 is a flowchart of an embodiment of an obtaining of quality indicators of an advertising flows process.

FIG. 6 is a flowchart of an embodiment of an obtaining of quality indicators process.

FIG. 7 is a flowchart of an embodiment of a process for obtaining flow quality comparison parameters for the off-site advertising spaces.

FIG. 8 is a flowchart of another embodiment of a process for obtaining flow quality comparison parameters for the off-site advertising spaces.

FIG. 9 is a flowchart of another embodiment of a process for generating flow quality comparison parameters.

FIG. 10 is a flow chart of an embodiment of a process for recommending off-site advertising spaces.

FIG. 11 is a structural diagram of an embodiment of a device for generating flow quality comparison parameters.

FIG. 12 is a structural diagram of an embodiment of an on-site quality indicator acquiring module.

FIG. 13 is a structural diagram of an embodiment of a device for recommending off-site advertising spaces.

FIG. 14 is a structural diagram of an embodiment of an advertisement billing device.

FIG. 15 is a structural diagram of an embodiment of a system for generating flow quality comparison parameters.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

In some embodiments, managing advertising flow includes: generating flow quality comparison parameters over a period of time based on click log data and transaction log data on relevant products or services advertised on off-site advertising spaces because flow quality comparison parameters are generated for on-site and off-site advertising flows. The flow quality comparison parameters for the off-site advertising spaces express parameter information relating off-site advertising prices to on-site advertising prices. The click log data and the transaction log data on products or services reflect advertising results of an advertising space, and the advertising results objectively and accurately reflect the website flow quality of a publisher's website. Typically, with regard to off-site advertising, in the event that the website flow quality is good, the advertisements will have good results. Therefore, flow quality comparison parameters for on-site and off-site advertising flows are automatically, efficiently, objectively, and accurately generated.

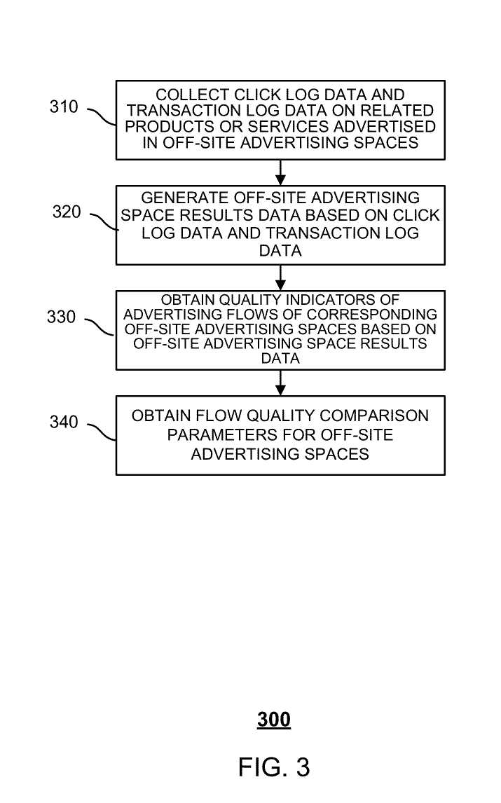

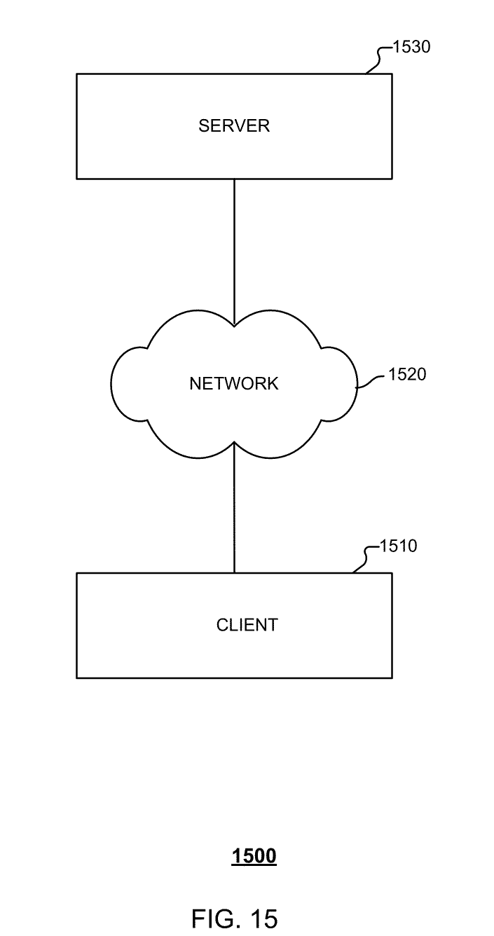

FIG. 3 is a flowchart of an embodiment of a process for generating flow quality comparison parameters. The process 300 can be implemented by a server 1530 of FIG. 15 and comprises:

In 310, the server collects click log data and transaction log data on related products or services advertised in off-site advertising spaces.

In some embodiments, various types of websites make use of two advertising modes: on-site advertising and off-site advertising. The server generates flow quality comparison parameters for off-site advertising spaces based on the click log data and the transaction log data on the related products or services advertised in the off-site advertising spaces. In some embodiments, the flow quality comparison parameters generated for the off-site advertising spaces accurately evaluate quality differences between on-site and off-site advertising flows.

“Off-site advertising” spaces generally refer to advertising spaces of a third party publisher. In some embodiments, a PID (Publisher ID) is used to uniquely identify a character string for an advertising space under a website of a publisher.

In some embodiments, after a user is linked to a transaction website by an advertisement of an on-site or off-site advertising space, the transaction website generally records the user's click log data and transaction log data in a log. Advertising space identification information (used to identify on-site advertising spaces and off-site advertising spaces), advertising flow information, product or service information, advertiser information, or any combination thereof are generally recorded within the click log data and the transaction log data. In some embodiments, the click log data stores data on whether other click actions exist after the user has clicked on an off-site advertisement link. In some embodiments, the “other click actions” refer to click actions on the transaction website that the user went to via an advertisement link. In some embodiments, the other click actions are captured through mouse or touchscreen events. For example, the other click actions include click actions such as “Buy Now,” “Add to Shopping Cart,” “Logon,” “Submit Order,” etc. In some embodiments, the transaction log data is used to record whether a user has concluded a transaction or performed a closing action after clicking on an off-site advertisement link. For example, closing actions include “I wish to make payment” or other such action after “Submit Order.”

In some embodiments, the click log data and the transaction log data include data on the relevant products or services advertised on the off-site advertising spaces over a period of time. In some embodiments, the “period of time” refers to a time range determined by a start time and an end time. The time period should not be too long; otherwise, the server will not be able to accurately reflect recent website flow quality of a publisher's website. The time period also should not be too short; otherwise, erroneous results data for one day within the time period could have a large impact on the current flow quality comparison parameters for off-site advertising spaces. In some embodiments, because the current day flow quality comparison parameters for the off-site advertising spaces are dynamically generated based on advertising results over a period of time, and the advertising results for that period of time can objectively and accurately reflect the recent website flow quality of the publisher's website, typically, for off-site advertising, if the website flow quality is good, the advertisement results are good. In addition, since comprehensive consideration is given in the generating of results data within the period of time in question process, erroneous results data for one day within the time period does not have a large impact on the current flow quality comparison parameters for off-site advertising spaces. Therefore, automatically, efficiently, objectively, and accurately generating flow quality comparison parameters for off-site advertising flows is possible.

In some embodiments, the current day is regarded as the end time. Accordingly, the period of time includes the period of time from 7 to 14 days from the current day to the current day. In some embodiments, the period of time is the period of time from 14 days before the current day to the current day. In some embodiments, persons skilled in the art, depending on actual conditions, can set the period of time to another length or another start time and end time. No restrictions in this regard are imposed.

In 320, the server generates off-site advertising space results data based on the click log data and the transaction log data.

In some embodiments, the server obtains the following types of results data: retention rate, close rate (GMV, Gross Merchandise Volume), return on investment (ROI), or any combination thereof based on the click log data and the transaction log data. The close rate is a ratio of the number of concluded deals to an attention level of product categories, the retention rate is a ratio of the number of operations following visits to the number of visits, and the ROI is a ratio of the concluded deal monetary benefit to inputs.

Table 1 presents acquisition methods, meanings, and updating periods for three types of results data on the Taobao website. The application examples are limited to the retention rate, the close rate, and the return on investment and are not meant to limit the applications.

TABLE 1

| Results | | | Update |
|---|---|---|---|
| Data | Acquisition Method | Meaning | period |
| Retention | (Visit quantity for other | Reflects whether a | Daily |
| rate | “treasures” at shop + | user performs | |
| | GMV Number of concluded | other click actions | |
| | transactions + Number | after clicking on | |
| | of registered page visits + | an advertisement | |
| | Bookmarks at shop + Number | | |
| | of “treasure” bookmarks)/ | | |
| | Current number of | | |
| | “treasure” visits | | |
| Close rate | GMV Number of concluded | Reflects whether a | Daily |
| | transactions/Total IPV | user performs a | |
| | (product category attention | closing action after | |
| | level, item page view) | clicking on an | |
| | | advertisement | |
| Return on | (Amount of in-shop | Reflects the | Daily |
| investment | transactions with direct | monetary results | |
| | Alipay + Amount of in- | from concluded | |
| | shop transactions with | transactions | |
| | indirect Alipay)/ | brought about by | |
| | Advertising spending | advertisements and | |
| | | the input-output | |
| | | ratio | |

In 330, the server obtains quality indicators of advertising flows of the corresponding off-site advertising spaces based on the off-site advertising space results data.

In some embodiments, the obtaining of the quality indicators of advertising flows of the corresponding off-site advertising spaces include calculating the weighted moving average of the off-site advertising space results data daily. In some embodiments, the weights of the daily off-site advertising space results data diminishes linearly or exponentially over time, and the most recent weights are greater than the next most recent weights.

The weighted moving average (WMA) refers to a multiplication of individual pieces of data by different numerical values during a calculation of averages. For example, assume that the off-site advertising space results data is being analyzed for the past 14 days. In this case, in order to accurately reflect the most recent website flow quality of a publisher's website, the most recent weight is greater than the next most recent weight when the weighted moving averages of the daily results data is calculated for the off-site advertising spaces over the period of time in question.

In some embodiments, weights diminish linearly over time. In some embodiments, weights diminish exponentially over time.

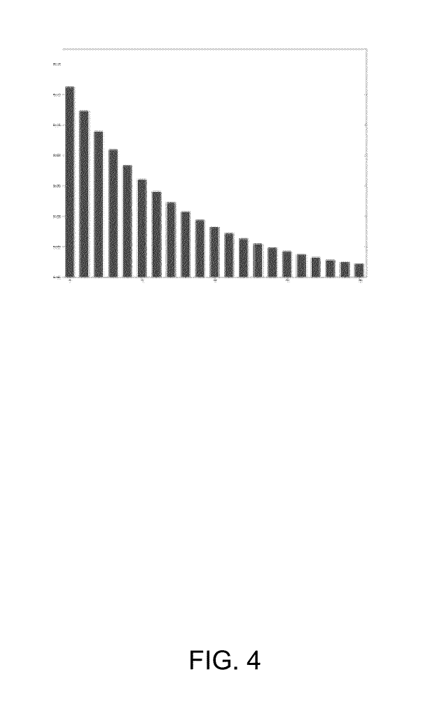

If, in the calculation of the weighted moving average of the results data for the past n days for the off-site advertising spaces, linear decay exists, the most recent results data is multiplied by n, the next most recent results data is multiplied by n−1, and so on until the results data is 0. FIG. 4 is a diagram of an embodiment of exponential decay of a weight over time. The Y coordinate corresponds with weight and the X coordinate corresponds with time. The weight decreases according to an exponential pattern as time elapses.

In some embodiments, if, when the weighted moving averages of the daily results data for the off-site advertising spaces are calculated over the period of time in question, the results data is missing for a certain day, the missing results data is processed as 0. In some embodiments, if the non-zero results data within the off-site advertising space group totals less than 3 days, the results data for the off-site advertising space group is discarded.

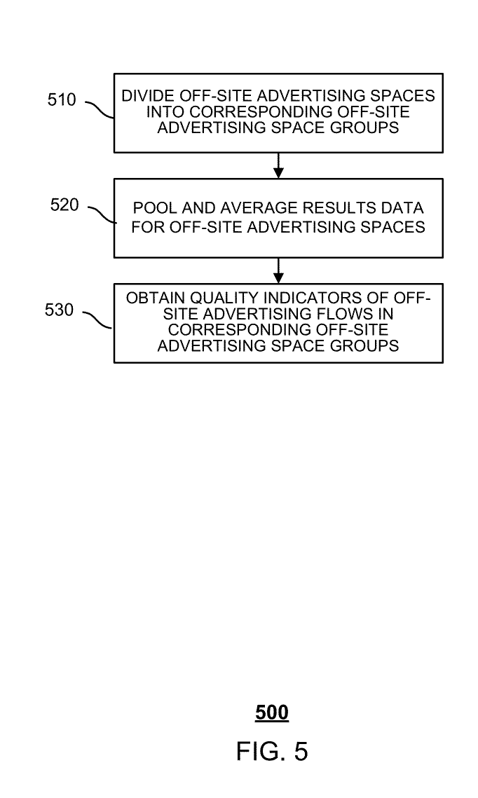

FIG. 5 is a flowchart of an embodiment of an obtaining of quality indicators of an advertising flows process. In some embodiments, the process 500 is an implementation of operation 330 and comprises:

In some embodiments, the quantity of off-site advertising spaces is large. Process 500 reduces the volume of calculations involved in the process of acquiring the quality indicators for advertising flows.

In 510, the server divides the off-site advertising spaces into corresponding off-site advertising space groups based on the advertising space identifiers and the advertising flow information recorded in the click log data and the transaction log data.

In 520, the server pools and averages the results data for the off-site advertising spaces, and obtains results data for the corresponding off-site advertising space groups.

In 530, the server obtains quality indicators of off-site advertising flows in the corresponding off-site advertising space groups by analyzing the results data of the off-site advertising space groups and regards these indicators as the quality indicators of advertising flows of the corresponding off-site advertising spaces.

Because the number of off-site advertising space groups is typically less than the number of off-site advertising spaces, obtaining quality indicators of off-site advertising flows is sufficient to analyze the results data of a certain number of off-site advertising space groups. In some embodiments, the analysis results correspond to the quality indicators of advertising flows of relevant off-site advertising spaces. In some embodiments, the process 500 reduces the volume of calculations involved in the process of acquiring the quality indicators for advertising flows.

In some embodiments, the advertising flow information includes flow type (flowType), product type (productType), product category (auctionCategory), or any combination thereof. The flow type is one of two types: on-site and off-site. Off-site is referred to here. Product type includes products that support off-site searches or products that do not support off-site searches. Product category refers to the product's category on the website (for example, men's apparel, women's apparel, sports and yoga, skin care, articles for daily use, furniture, bedding, shoes, etc.).

For example, an off-site advertising space group is represented using expression (1):

Group(pid, flowType, productType,auctionCategory) (1)

In some embodiments, in the process of generating the quality indicators for off-site advertising flows in off-site advertising space groups, weighted moving averages are calculated for daily results data for the off-site advertising space groups over a period of time. In some embodiments, weights of the daily results data of the off-site advertising space groups over the period of time in question decreases linearly or exponentially with time. In some embodiments, the most recent weight is greater than the next most recent weight.

For example, when the results data of the off-site advertising space groups include one of three types of results data (retention rate, close rate, and return on investment), as shown in formulas (2), (3) and (4), calculating the weighted averages for retention rate, close rate, and return on investment using time decay weights is possible:

Avg_{retentionRate}·(Group)=Avg_{retentionRate}·(pid, flowType, productType,auctionCategory) (2)

Avgᵣₒᵢ(Group)=Avgᵣₒᵢ·(pid, flowType, productType,auctionCategory) (3)

Avg_{gmv}·(Group)=Avg_{gmv}·(pid, flowType, productType,auctionCategory) (4)

In some embodiments, a map/reduce programming model performs the analytic calculations on the click log data and the transaction log data. Because websites typically use a plurality of servers to store the click log data and the transaction log data on website products or services, the click log data and the transaction log data are stored in columns. A “column” refers, in this example, to a conceptual list composed of independent elements.

Thus, a map function performs a designated operation on each element of a list. Each element is independently operated on, but the original list is not altered, for a new list is created to save the new answers. In other words, the map function is processed in parallel, which is very useful for applications which have high performance requirements and demand parallel computing. In some embodiments, a reduce function performs appropriate mergers on the elements of the list. Although the reduce function is not as parallel as the map function, the reduce function is also very useful in a parallel computing environment because the reduce function has simple answer and large-scale calculations that are relatively independent.

For example, in some embodiments, the map function calculates results data by processing the click log data and the transaction log data of a server and divides the results data into groups to obtain the relevant off-site advertising space groups. Next, the reduce function merges the results data that are in the same off-site advertising space group on the same server.

In 340, the server obtains flow quality comparison parameters for the off-site advertising spaces based on the quality indicators of advertising flows of the off-site advertising spaces.

In some embodiments, because the quality indicators for advertising flows of off-site advertising spaces are derived from retention rate, close rate, and return on investment of off-site advertising space groups over the period of time in question, the quality indicators directly reflect the advertising results of the off-site advertising space groups over the period of time and thus indirectly, objectively, and accurately reflect the most recent website flow quality of the publisher's website. In the case of off-site advertising, in the event that the publisher website flow quality is good, typically the advertisement results are good. In this situation, the flow quality comparison parameters for on-site and off-site advertising flows being larger reflect the proper differences and imbalances between on-site and off-site advertising flow quality.

The obtaining of the flow quality comparison parameters for the off-site advertising spaces based on the quality indicators of advertising flows of the off-site advertising spaces includes:

In some embodiments, the obtaining of the flow quality comparison parameters uses preset quality indicators of on-site advertising flows as reference values. In some embodiments, the flow quality comparison parameters for the off-site advertising spaces are obtained by comparing the quality indicators of advertising flows of the off-site advertising spaces with the preset quality indicators of on-site advertising flows.

In addition, in some embodiments, the values set for results data such as retention rate, close rate, return on investment for off-site advertising spaces over the period of time in question are within the interval range of [0, 1]. The values set for results data are still within the interval range of [0,1] after weighted moving averages have been calculated.

Therefore, as an example, a preset quality indicator for onsite advertising flow is 1. At this point, the quality indicators of advertising flow for off-site advertising spaces are the flow quality comparison parameters for the relevant off-site advertising spaces. In some embodiments, a quality indicator of on-site advertising flow is preset (for example, any value within [0.9, 0.9999]) based on empirical values or the advertising results of the on-site advertisements over the period of time. In summary, persons skilled in the art can preset quality indicators of on-site advertising flows based on the actual conditions of on-site advertising over the period of time or based on other parameters. For example, the off-site flow quality is discounted based on the on-site flow quality. For example, if off-site advertisements are related to the automotive industry and on-site advertisements are related to Women's clothing, then the off-site flow quality would have a lower weight. For example, if the on-site flow quality is set to a value of 1, then the off-site flow quality may be set to 0.3. There are no limitations on the manner in which the presetting is performed or on numerical values following presetting.

In another example, the flow quality comparison parameters for the off-site advertising spaces are obtained by comparing the quality indicators of advertising flows of the off-site advertising spaces with analytically and statistically derived quality indicators of on-site advertising flows.

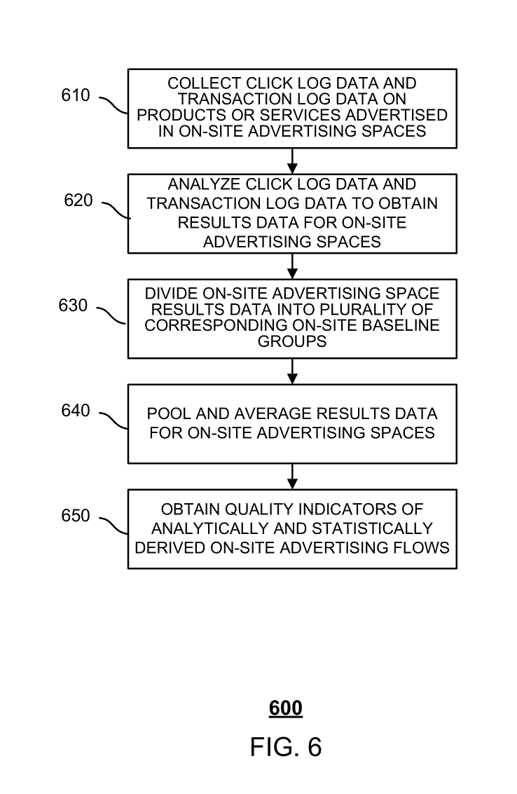

FIG. 6 is a flowchart of an embodiment of an obtaining of quality indicators process. In some embodiments, the process 600 implements 530 of FIG. 5 and comprises:

In 610, the server collects the click log data and the transaction log data on the products or the services advertised in on-site advertising spaces.

In 620, the server analyzes the click log data and the transaction log data to obtain results data for the on-site advertising spaces.

In 630, the server divides the on-site advertising space results data into a plurality of corresponding on-site baseline groups based on the advertising flow information.

In 640, the server pools and averages the results data for the on-site advertising spaces, and obtains results data for the corresponding on-site baseline space groups.

In 650, the server obtains quality indicators of analytically and statistically derived on-site advertising flows by analyzing and statistically compiling the results data for the on-site baseline groups.

In yet another example, the previous two examples express the flow quality comparison parameters for off-site advertising spaces as parameter information relating off-site advertising prices to on-site advertising prices. This example employs flow quality comparison parameters for off-site advertising spaces to express differences in flow quality of off-site advertising spaces among numerous off-site advertising spaces.

The example includes: obtaining the flow quality comparison parameters for the off-site advertising spaces based on a comparison of the quality indicators of the advertising flows of the off-site advertising spaces with averages of the quality indicators of advertising flows of the off-site advertising spaces.

The obtaining of the flow quality comparison parameters for the off-site advertising spaces based on the comparison of the quality indicators of the advertising flows of the off-site advertising spaces with the averages of the quality indicators of the advertising flows of the off-site advertising spaces in off-site advertising space groups is possible.

In some embodiments, when the results data includes more than one type of results data, as shown in formulas (2), (3) and (4), the quality indicators of advertising flows of the off-site advertising spaces include the quality indicators of off-site advertising flows of various types of results data.

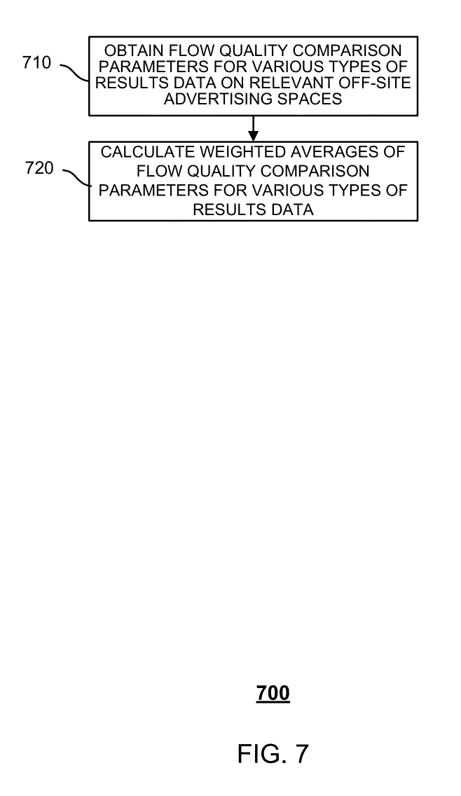

FIG. 7 is a flowchart of an embodiment of a process for obtaining flow quality comparison parameters for the off-site advertising spaces. In some embodiments, the process 700 is an implementation of 340 of FIG. 3 and comprises:

In 710, the server obtains flow quality comparison parameters for various types of results data on relevant off-site advertising spaces based on the quality indicators of off-site advertising flows of various types of results data.

In 720, the server calculates weighted averages of the flow quality comparison parameters for the various types of results data based on weights of the various types of results data, and obtains flow quality comparison parameters for the relevant off-site advertising spaces.

Assume that the on-site/off-site advertising flow quality comparison parameters corresponding to retention rate, return on investment, and close rate and Discount_{retentionRate}, Discountᵣₒᵢ and Discount_{gmv}, respectively, and weights corresponding to retention rate, return on investment, and close rate are α, β and χ, respectively. Discount_{retentionRate}, Discountᵣₒᵢ and Discount_{gmv} relate to discount (or flow quality comparison rate) for the following dimensions: retention rate, return on investment (ROI), and gross merchandise volume (GMV). In some embodiments, the three dimensions of the flow quality comparison rate are calculated, and then a weighted average of the three dimensions is used to evaluate the off-site advertising spaces. Thus, formula (5) is used to calculate the on-site/off-site flow quality comparison parameters for the relevant off-site advertising spaces, where a person skilled in the art, according to actual conditions, sets each of α, β and χ within [0,1], and α+β+χ=1:

Discount(Group(pid))=αDiscount_{retentionRate}+βDiscountᵣₒᵢ+χDiscount_{gmv} (5)

In some embodiments, when the advertising flow information includes product categories, the quality indicators of advertising flows of the off-site advertising spaces include the quality indicators of the off-site advertising flows of the off-site advertising space groups corresponding to the various product categories.

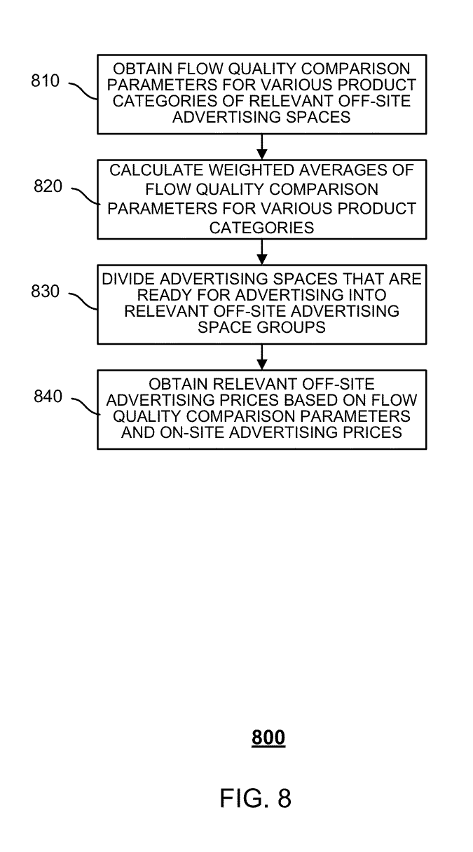

FIG. 8 is a flowchart of another embodiment of a process for obtaining flow quality comparison parameters for the off-site advertising spaces. In some embodiments, the process 800 is an implementation of 340 of FIG. 3 and comprises:

In 810, the server obtains the flow quality comparison parameters for the various product categories of the relevant off-site advertising spaces based on the quality indicators of off-site advertising flows corresponding to various product categories.

In 820, the server calculates weighted averages of the flow quality comparison parameters for the various product categories based on the weights of the various product categories and obtains the flow quality comparison parameters for the relevant off-site advertising spaces.

In process 800, the weights of product categories correspond to the ratios of the off-site advertising flows of the product categories to the off-site advertising flows of all product categories.

For example, using Taobao, the weighted, final flow quality comparison parameters for the off-site advertising spaces are calculated based on the display flow proportion of each PID within the various “treasure” categories (PID+flowtype). The related calculations are as shown in formula (6):

Discount(pid)=FlowRate₁*Discount(Group₁(pid))+FlowRate₂*Discount(Group₂(pid))+ . . . +FlowRateₙ*Discount(Groupₙ(pid)) (6)

Discount(Groupₙ(pid)) is a flow quality comparison parameter of the off-site advertising spaces in off-site advertising space group n corresponding to the n^{th} product category,

$${FlowRate}_{i} = \frac{{Flow}_{i}}{TotalFlow}$$

indicates weight of the i^{th} product category, Flowᵢ indicates the off-site advertising flow of the i^{th} product category, and TotalFlow indicates the off-site advertising flow of all product categories.

In some embodiments, the relevant off-site advertising flow is obtained based on click log data for the product over the period of time in question. Assume that the total flow drawn to Taobao for a PID is 100, and the flow that is drawn to men's apparel is 10. In this case, the weight for men's apparel is 10/100=0.1.

As an example, because the flow quality comparison parameters for off-site advertising spaces indicate parameter information relating off-site advertising prices to on-site advertising prices, all advertising spaces use the same off-site advertising prices. Therefore, in this situation, the current-day off-site advertising prices is set for the prepared advertising spaces directly based on on-site/off-site advertising flow quality comparison parameters and on-site advertising prices.

In some embodiments, the process 800 further comprises:

In 830, the server divides advertising spaces that are ready for advertising into relevant off-site advertising space groups based on advertising flow information.

In 840, for advertising spaces that are ready for advertising, the server obtains the relevant off-site advertising prices based on the flow quality comparison parameters and on-site advertising prices.

In some embodiments, a principle whereby sets off-site advertising prices is: the group to which a PID belongs when the current-day off-site advertising prices are being set is the same group to which its historical data belong over the period of time in question. In other words, if the off-site advertising space group to which a space ready for advertising belongs is Group(pid, flowType, productType,auctionCategory), then the off-site advertising space flow quality comparison parameters for Group(pid, flowType, productType,auctionCategory) is used when prices are being set. Of course, the off-site advertising space group to which a space ready for advertising belongs can also be Group(pid, flowType), Group(pid, productType), Group(pid, auctionCategory), Group(pid), or another group. No limitations on specific groups are imposed.

The technical measures adopted in operations 310-340 of FIG. 3 objectively and accurately generate flow quality comparison parameters for on-site/off-site advertising and off-site advertising spaces and thus accurately evaluate differences in quality of off-site advertising spaces. In addition, in some embodiments, when the flow quality comparison parameters for the off-site advertising spaces express parameter information relating off-site advertising prices to on-site advertising prices, the flow quality comparison parameters accurately evaluate differences in the quality of on-site and off-site advertising flows. Thus, helping advertisers during the Internet advertising process to better select the most appropriate on-site and off-site advertising flow resources is possible based on attributes of the products or services that are to be advertised.

In some embodiments, on-site advertising flow resources generally are advertised internally on transaction websites, while off-site advertising flow resources are generally advertised on the websites of other publishers outside of the transaction websites. The attributes of the products or services here that are to be advertised include the categories (for example, digital, appliances, men's apparel, women's apparel) to which the products or services belong, the population (for example, men, women, etc.) targeted by the products or services, etc.

For example, on-site advertising spaces are generally used to promote transactions, while off-site advertising spaces are generally used to promote brand reputation. Therefore, when an advertiser's intention is to promote transactions relating to products or services to-be-advertised, the advertiser generally selects on-site advertising flow resources to perform the advertising. However, the fact that the most recent flow quality comparison parameter (assume a value above 0.6, such as 0.9) for off-site advertising spaces is higher indicates that an off-site advertising space has better advertising results. Therefore, in this case, ready-to-advertise data can also be diverted to the off-site advertising flow resources for advertising. By the same principle, the fact that the most recent flow quality comparison parameter (assume a value below 0.6, such as 0.3) for off-site advertising spaces is lower indicates that an off-site advertising has poorer advertising results. Therefore, in this case, diverting ready-to-advertise to the off-site advertising flow resources for advertising is not appropriate. In summary, improvements in utilization efficiency of on-site and off-site advertising flow resources and promotion of the development of advertising technology and network transaction platforms can occur.

In some embodiments, the flow quality comparison parameters for off-site advertising spaces are also used to bill for advertisements. Examples of advertisement billing include: acquiring advertising space identifying information and advertiser information based on the click log data and the transaction log data on products or services, and billing relevant advertisers according to the flow quality comparison parameters for the off-site advertising spaces when the advertising space identifying information is for off-site advertising space. One understands that, when the advertising space identifying information is for on-site advertising spaces, the relevant advertisers are billed based on on-site advertising flow quality. Accordingly, a more detailed discussion of billing the relevant advertisers based on on-site advertising flow quality is omitted for conciseness.

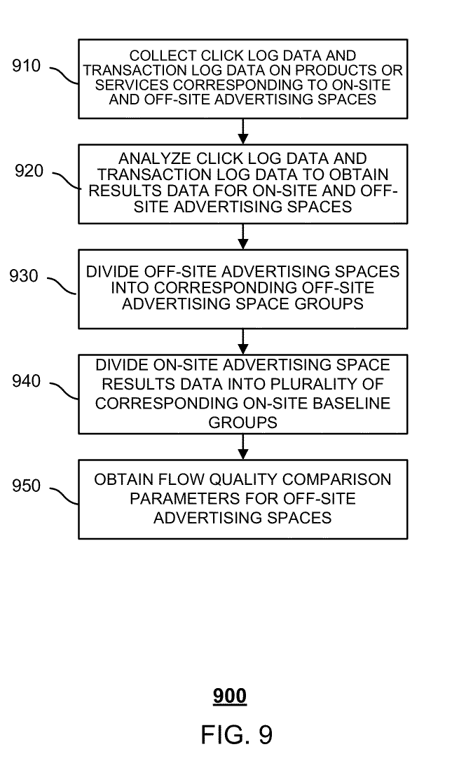

FIG. 9 is a flowchart of another embodiment of a process for generating flow quality comparison parameters. The process 900 can be implemented by a server 1530 of FIG. 15 and comprises:

In 910, the server collects click log data and transaction log data on products or services corresponding to on-site and off-site advertising spaces. In some embodiments, the on-site and the off-site advertising spaces include on-site advertising spaces and off-site advertising spaces.

In 920, the server analyzes the click log data and the transaction log data to obtain results data for the on-site and the off-site advertising spaces.

In 930, the server divides the off-site advertising spaces into corresponding off-site advertising space groups based on advertising space identifiers and advertising flow information recorded in the click log data and the transaction log data. In some embodiments, the server pools and averages the results data for the off-site advertising spaces, and obtains results data for the off-site advertising space groups. Moreover, the server obtains quality indicators of off-site advertising flows in the corresponding off-site advertising space groups by analyzing the results data of the off-site advertising space groups, and regards these indicators as the quality indicators of the advertising flows of the corresponding off-site advertising spaces.

In 940, the server divides the on-site advertising space results data into a plurality of corresponding on-site baseline groups based on the advertising flow information. In some embodiments, the server pools and averages the results data for the on-site advertising spaces and obtains results data for the corresponding on-site baseline groups. Moreover, the server obtains quality indicators of analytically and statistically derived on-site advertising flows by analyzing and statistically compiling the results data for the on-site baseline groups.

In 950, the server obtains flow quality comparison parameters for the off-site advertising spaces by comparing quality indicators of the advertising flow of the off-site advertising spaces with the analytically and statistically derived quality indicators of on-site advertising flows.

Process 900 differs from process 300 as follows: in process 900, the server analyzes and statistically compiles the results data on products or services corresponding to on-site advertising spaces to obtain quality indicators of on-site advertising flows. Because the results data for on-site advertising spaces can in itself directly reflect their advertising results over the period of time in question, the results data can thus indirectly, objectively, and accurately reflect the most recent website flow quality on a website. Therefore, analytically and statistically derived quality indicators of on-site advertising flows serve as reference values for generating flow quality comparison parameters for off-site advertising spaces which can objectively, accurately, and realistically reflect the differences and imbalances in advertising flow quality between off-site advertising spaces and on-site advertising spaces.

In some embodiments, the results data for the on-site advertising spaces include the following types: retention rate, close rate, return on investment, or any combination thereof

In some embodiments, the advertising flow information that serves as the basis for grouping the results data on the on-site advertising spaces includes the following types of advertising flow information: flow type (flowType), product type (productType), product category (auctionCategory), or any combination thereof. The flow type includes two types: on-site and off-site. This example refers to the on-site flow type. Product type is used to include products that support on-site searches or that do not support on-site searches. Product category refers to the product's category on the website (for example, men's apparel, women's apparel, sports and yoga, skin care, articles for daily use, furniture, bedding, shoes, etc.).

Since analyzing the results data of on-site baseline groups is performed to obtain reference values for off-site advertising flow quality, a difference between on-site baseline groups and off-site advertising space groups is that the on-site baseline groupings uses advertising space identification (PID), while the off-site advertising space groups do not use advertising space identification (PID). Therefore, the formats of the two groupings differ accordingly. For example, one type of format for an on-site baseline group is shown in formula (7):

Group_{baseline}(flow Type, productType,auctionCategory) (7)

In some embodiments, the analyzing of the results data on the on-site baseline groups to obtain quality indicators for on-site advertising flow includes: calculating weighted moving averages of the daily results data of the off-site advertising spaces over the period of time in question for the on-site baseline groups, where the weights of the daily results data of the off-site advertising spaces over the period of time for the on-site baseline groups decrease linearly or exponentially with time, and the most recent weight is greater than the next most recent weight.

Assuming that the server analyzes the last 14 days of off-site advertising space group results data for on-site baseline groups. In that case, in order to accurately reflect the most recent on-site website flow quality of a publisher's website, the server calculates a weighted moving average of the daily results data of the off-site advertising spaces over the period of time in question for the on-site baseline groups, and the most recent weight is greater than the next most recent weight. The weight decreases either linearly or exponentially.

In some embodiments, if the weighted moving average that is calculated for the last n days of results data for on-site baseline groups is calculated according to linear decay, the most recent results data is multiplied by n, the next most recent by n−1, etc. until n is equal to 0. FIG. 4 illustrates exponential decay of a weight over time. In other words, the weight is reduced according to an exponential pattern as time elapses.

In some embodiments, if, when the weighted moving averages of the daily results data over the period of time in question for the on-site baseline groups are being calculated, the results data is missing for a certain day, the server processes the missing results data as 0. In some embodiments, if the non-zero results data within the off-site advertising space group totals less than 3 days, the results data for this off-site advertising space group is discarded.

When the results data for the on-site baseline groups include results data (retention rate, close rate, return on investment(ROI), or any combination thereof), the weighted averages for retention rate, close rate, and ROI are calculated according to time decay weights as shown by formulas (8), (9) and (10), where on-site baseline groups are indicated:

Avg_{retentionRate}·(Group_{baseline})=Avg_{retentionRate}·(flowType, productType, auctionCategory) (8)

Avgᵣₒᵢ·(Group_{baseline})=Avgᵣₒᵢ·(flowType, productType,auctionCategory) (9)

Avg_{gmv}·(Group_{baseline})=Avg_{gmv}·(flowType, productType,auctionCategory) (10)

In some embodiments, in operation 950, the server first takes each type of results data grouped according to the off-site advertising space groups as the granularity and uses formulas (11), (12) and (13) to calculate the flow quality comparison parameters of the on-site/off-site advertising flows and then uses formula (5) to calculate the flow quality comparison parameters for the off-site advertising spaces.

$$\begin{matrix}{Discount}_{retentionRate} ( Group ( pid ) ) = \frac{{Avg}_{retentionRate} ( Group )}{{Avg}_{{retentionRate}^{′}} ( {Group}_{baseline} )} & ( 11 ) \\ {Discount}_{roi} ( Group ( pid ) ) = \frac{{Avg}_{roi} ( Group )}{{Avg}_{{roi}^{′}} ( {Group}_{baseline} )} & ( 12 ) \\ {Discount}_{gmv} ( Group ( pid ) ) = \frac{{Avg}_{gmv} ( Group )}{{Avg}_{{gmv}^{′}} ( {Group}_{baseline} )} & ( 13 )\end{matrix}$$

If Discountₜ(Group(pid))(tε(retentionRate, ROI, GMV))>1, the server sets the flow quality comparison parameter for the off-site advertising spaces for the type of results data in question to 1.

Since process 900 is similar to process 300, the description of process 900 is simplified. Refer to the partial explanations of process 300 where appropriate.

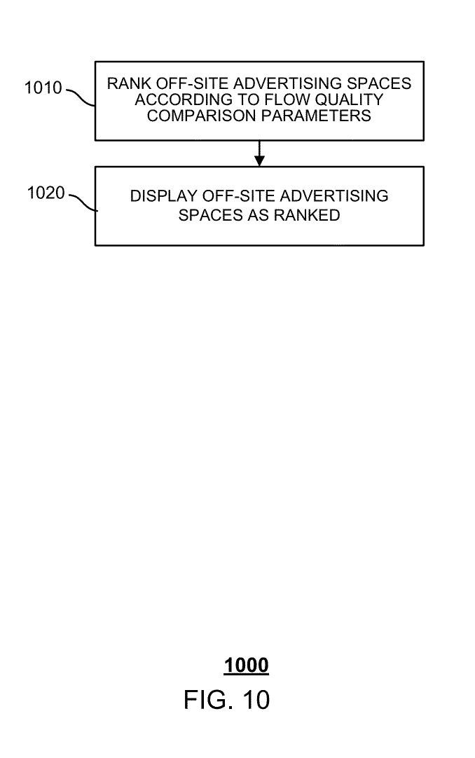

FIG. 10 is a flow chart of an embodiment of a process for recommending off-site advertising spaces. The process 1000 can be implemented by a server 1530 of FIG. 15 and comprises:

In 1010, the server ranks off-site advertising spaces according to flow quality comparison parameters in order of large to small. The flow quality comparison parameters are generated using the processes for generating flow quality comparison parameters described above.

In 1020, the server displays the off-site advertising spaces as ranked when a user advertises through an advertising server.

An example of an advertising process is as follows: An advertising server, as instructed by an advertiser, selects on-site advertising flow resources, off-site advertising flow resources, or a combination thereof for products or services that are to be advertised and places the resources on the appropriate websites. These on-site advertising flow resources correspond to on-site advertising spaces and are generally placed internally on a transaction website. These off-site advertising flow resources correspond to off-site advertising spaces and are generally placed on a publisher website other than a transaction website.

Conventionally, advertisers have a limited understanding of off-site advertising spaces. Typically, the advertisers only know that the off-site advertising spaces advertise products or services on a publisher's website other than a transaction website. The advertisers do not specifically know on which the publisher's website they are published. In some situations, the advertisers know the publisher's website (which is a website other than a transaction website) on which the products or services are advertised. However, the advertisers know nothing about advertising results of the off-site advertising spaces because the publisher's website is not necessarily related to the advertising results of the off-site advertising spaces. Therefore, conventionally, the advertisers may expend large amounts of time and energy in selecting off-site advertising spaces.

In some embodiments, off-site advertising spaces are ranked according to flow quality comparison parameters in order from large to small, and when users advertise through advertising servers, the advertising servers display the off-site advertising spaces in the order the off-site advertising spaces were ranked. The flow quality comparison parameters enable an evaluation of quality differences between the off-site advertising spaces. As an example, since the flow quality comparison parameters for the off-site advertising spaces indicate parameter information relating off-site advertising prices to on-site advertising prices, the flow quality comparison parameters enable an accurate evaluation of quality differences between off-site and on-site advertising spaces. Accordingly, the advertising results of off-site advertising spaces placed in front are greater than the advertising results of off-site advertising spaces placed in back. Thus, information related to the advertising results of off-site advertising spaces can be displayed. Off-site advertising reference information can be provided to users and thus make off-site advertising more convenient for users.

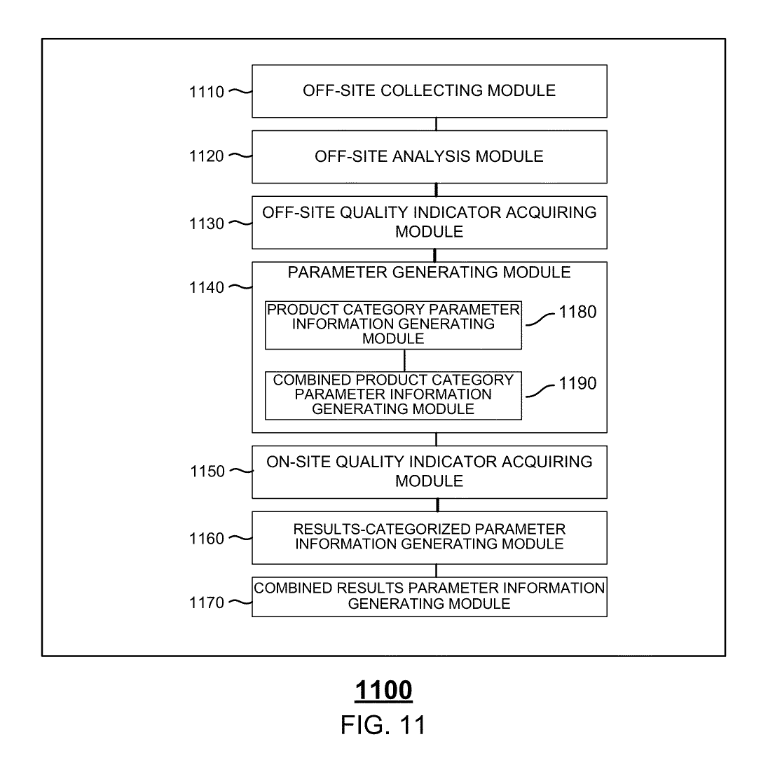

FIG. 11 is a structural diagram of an embodiment of a device for generating flow quality comparison parameters. The device 1100 comprises an off-site collecting module 1110, an off-site analysis module 1120, an off-site quality indicator acquiring module 1130, and a parameter generating module 1140.

The off-site collecting module 1110 collects click log data and transaction log data on relevant products or services advertised in off-site advertising spaces.

The off-site analysis module 1120 generates results data of the off-site advertising spaces based on an analysis of the click log data and the transaction log data.

The off-site quality indicator acquiring module 1130 obtains quality indicators of advertising flows of the corresponding off-site advertising spaces based on the results data of the off-site advertising spaces.

The parameter generating module 1140 obtains flow quality comparison parameters for the off-site advertising spaces based on the quality indicators of the off-site advertising flows within off-site advertising space groups.

In some embodiments, the parameter generating module 1140 also obtains the flow quality comparison parameters for the off-site advertising spaces based on a comparison of the quality indicators of advertising flows of the off-site advertising spaces with preset quality indicators of on-site advertising flow.

In some embodiments, the parameter generating module 1140 further obtains the flow quality comparison parameters for the off-site advertising spaces based on a comparison of the quality indicators of the advertising flows of the off-site advertising spaces with averages of the quality indicators of advertising flows of all off-site advertising spaces.

In some embodiments, the off-site quality indicator acquiring module 1130 divides the off-site advertising spaces into corresponding off-site advertising space groups based on the advertising space identifiers and the advertising flow information recorded in the click log data and the transaction log data, pools and averages the results data for the off-site advertising spaces and obtains results data for the corresponding off-site advertising space groups, and obtains quality indicators of off-site advertising flows in the corresponding off-site advertising space groups by analyzing the results data of the off-site advertising space groups and regarding these indicators as the quality indicators of advertising flows of the corresponding off-site advertising spaces.

In some embodiments, the device 1100 further comprises an on-site quality indicator acquiring module 1150.

The on-site quality indicator acquiring module 1150 analyzes and statistically compiles quality indicators of on-site advertising flows.

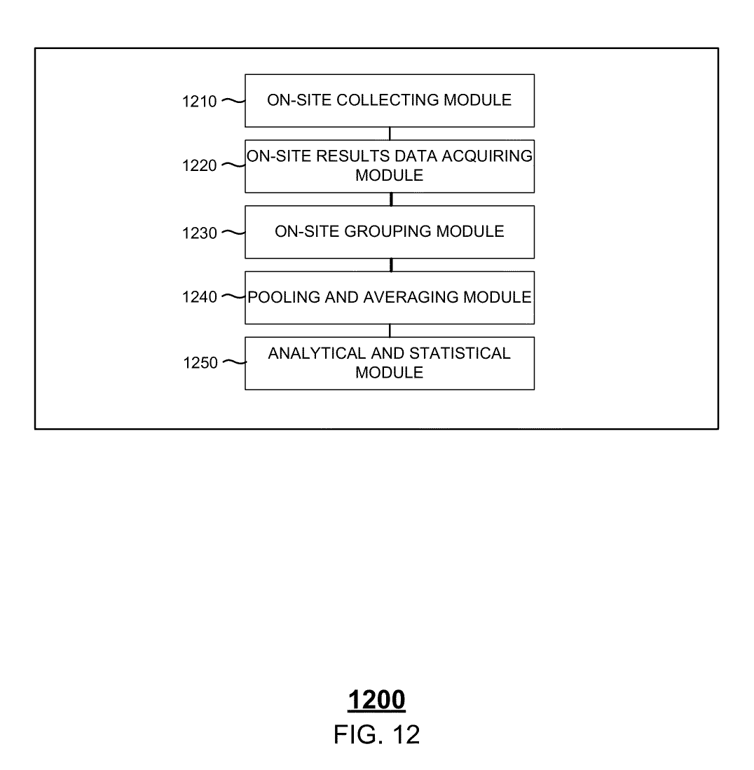

FIG. 12 is a structural diagram of an embodiment of an on-site quality indicator acquiring module. In some embodiments, the on-site quality indicator acquiring module 1200 is an implementation of the on-site quality indicator acquiring module 1150 and comprises an on-site collecting module 1210, an on-site results data acquiring module 1220, an on-site grouping module 1230, a pooling and averaging module 1240, and an analytical and statistical module 1250.

The on-site collecting module 1210 collects click log data and transaction log data on products or services advertised in on-site advertising spaces.

The on-site results data acquiring module 1220 obtains results data for on-site advertising spaces based on the click log data and the transaction log data.

The on-site grouping module 1230 divides the on-site advertising space results data into multiple corresponding on-site baseline groups based on advertising flow information.

The pooling and averaging module 1240 pools and averages the results data for the on-site advertising spaces and obtains results data for the corresponding on-site baseline groups.

The analytical and statistical module 1250 obtains quality indicators of analytically and statistically derived on-site advertising flows by analyzing and statistically compiling the results data for the on-site baseline groups.

In some embodiments, the click log data and the transaction log data are click log data and transaction log data collected over a period of time.

In some embodiments, the results data include the following types of results data: retention rate, close rate, return on investment, or any combination thereof. The close rate is the ratio of the number of concluded deals to the attention level of product categories, the retention rate is the ratio of the number of operations following visits to the number of visits, and the return on investment is the ratio of the concluded deal monetary benefit to inputs.

In some embodiments, when the results data includes a plurality of types of results data, the pooling of quality indicators of advertising flows of the off-site advertising spaces includes the off-site advertising flow quality indicators for various types of results data.

In this case, the device 1100 further comprises a results-categorized parameter information generating module 1160 and a combined results parameter information generating module 1170.

The results-categorized parameter information generating module 1160 obtains flow quality comparison parameters for various types of results data on relevant off-site advertising spaces based on the quality indicators of off-site advertising flows of the various types of results data.

The combined results parameter information generating module 1170 calculates weighted averages of the on-site/off-site advertising flow quality comparison parameters for the various types of results data based on the weights of the various types of results data and obtains the flow quality comparison parameters for the off-site advertising spaces.

In some embodiments, the advertising flow information includes the following advertising flow information: flow type, product type, product category, or any combination thereof

In some embodiments, when the advertising flow information includes product categories, the quality indicators of advertising flows of the off-site advertising spaces include the quality indicators of the off-site advertising flows of off-site advertising space groups corresponding to the various product categories.

In some embodiments, the parameter generating module 1140 further comprises a product category parameter information generating module 1180 and a combined product category parameter information generating module 1190.

The product category parameter information generating module 1180 obtains flow quality comparison parameters for the various product categories of the relevant off-site advertising spaces based on the quality indicators of off-site advertising flows of off-site advertising space groups corresponding to the various product categories.

The combined product category parameter information generating module 1190 calculates weighted averages of the on-site/off-site advertising flow quality comparison parameters for the various product categories based on the weights for the various product categories and obtains the flow quality comparison parameters for the corresponding off-site advertising spaces.

In some embodiments, the weights of product categories are the ratios of the off-site advertising flows of these product categories to the off-site advertising flows of all product categories.

In some embodiments, the off-site quality indicator acquiring module 1130 calculates weighted moving averages of the daily results data of the off-site advertising spaces over a period of time. The weights of the daily results data of the off-site advertising spaces over the period of time decrease linearly or exponentially with time. The most recent weight is greater than the next most recent weight.

In some embodiments, the period of time includes the period of time from 7 to 14 days from the current day to the current day.

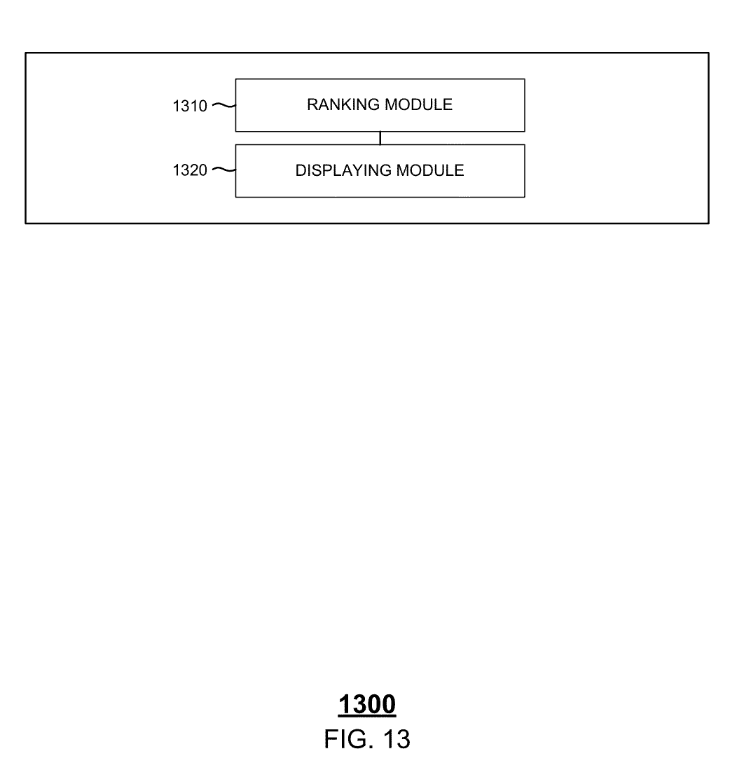

FIG. 13 is a structural diagram of an embodiment of a device for recommending off-site advertising spaces. The device 1300 includes a ranking module 1310 and a displaying module 1320.

The ranking module 1310 ranks off-site advertising spaces according to flow quality comparison parameters in order from large to small. The flow quality comparison parameters are generated using the flow quality comparison parameter generating device 1100 described above.

The displaying module 1320 displays the ranked off-site advertising spaces when advertising is carried out through an advertising server.

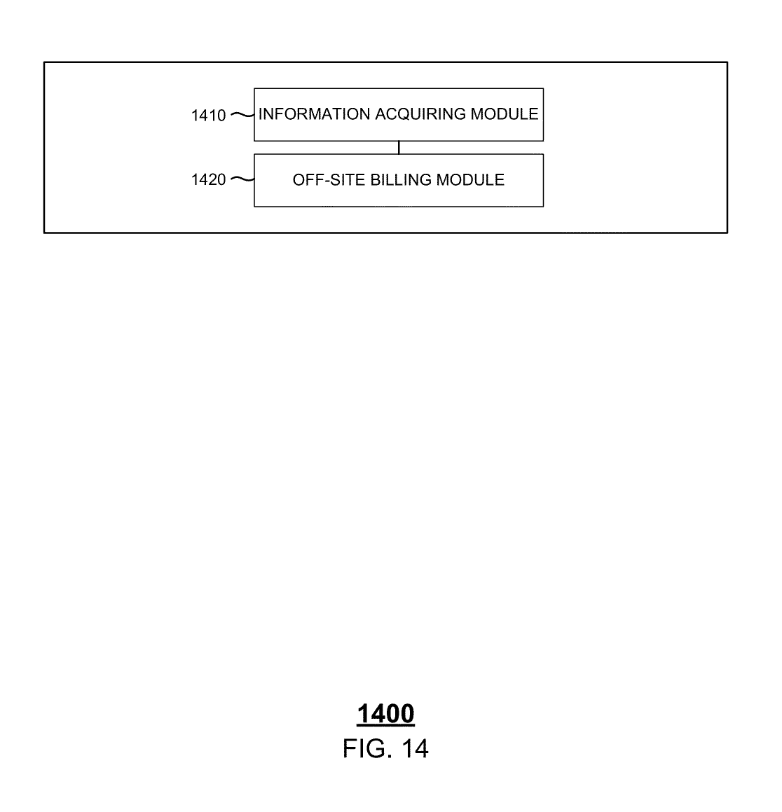

FIG. 14 is a structural diagram of an embodiment of an advertisement billing device. The advertisement billing device 1400 includes an information acquiring module 1410 and an off-site billing module 1420.

The information acquiring module 1410 acquires advertising space identifying information and advertiser information based on click log data and transaction log data on products or services.

The off-site billing module 1420 bills the relevant advertisers according to flow quality comparison parameters for off-site advertising spaces when the advertising space identifying information is for the off-site advertising space.

FIG. 15 is a structural diagram of an embodiment of a system for generating flow quality comparison parameters. The system 1500 includes a client 1510 connected via a network 1520 to a server 1530.

The units described above can be implemented as software components executing on one or more general purpose processors, as hardware such as programmable logic devices and/or Application Specific Integrated Circuits designed to perform certain functions or a combination thereof. In some embodiments, the units can be embodied by a form of software products which can be stored in a nonvolatile storage medium (such as optical disk, flash storage device, mobile hard disk, etc.), including a number of instructions for making a computer device (such as personal computers, servers, network equipment, etc.) implement the methods described in the embodiments of the present invention. The units may be implemented on a single device or distributed across multiple devices. The functions of the units may be merged into one another or further split into multiple sub-units.

The methods or algorithmic steps described in light of the embodiments disclosed herein can be implemented using hardware, processor-executed software modules, or combinations of both. Software modules can be installed in random-access memory (RAM), memory, read-only memory (ROM), electrically programmable ROM, electrically erasable programmable ROM, registers, hard drives, removable disks, CD-ROM, or any other forms of storage media known in the technical field.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method for generating flow quality comparison parameters, comprising:
collecting click log data and transaction log data on relevant products or services advertised in off-site advertising spaces;
generating off-site advertising space results data based at least in part on the click log data and the transaction log data;
obtaining quality indicators of advertising flows of the corresponding off-site advertising spaces based on the off-site advertising space results data; and
obtaining flow quality comparison parameters for the off-site advertising spaces based at least in part on the quality indicators of the advertising flows of the off-site advertising spaces, the flow quality comparison parameters relating to a comparison of off-site advertising prices to on-site advertising prices.

2. The method as described in claim 1, wherein the obtaining of the flow quality comparison parameters for the off-site advertising spaces based on the quality indicators of the advertising flows of the off-site advertising spaces comprises:
obtaining the flow quality comparison parameters for the off-site advertising spaces by comparing the quality indicators of the advertising flows of the off-site advertising spaces with preset or analytically and statistically derived quality indicators of on-site advertising flows.

3. The method as described in claim 1, wherein the obtaining of the flow quality comparison parameters for the off-site advertising spaces based on the quality indicators of the advertising flows of the off-site advertising spaces comprises:
obtaining the flow quality comparison parameters for the off-site advertising spaces by comparing the quality indicators of the advertising flows of the off-site advertising spaces with averages of the quality indicators of the advertising flows of the off-site advertising spaces.

4. The method as described in claim 1, wherein the obtaining of the flow quality comparison parameters for the off-site advertising spaces based on the quality indicators of the advertising flows of the off-site advertising spaces comprises:
dividing the off-site advertising spaces into corresponding off-site advertising space groups based on advertising space identifiers and advertising flow information recorded in the click log data and the transaction log data;
pooling and averaging the results data for the off-site advertising spaces and obtaining results data for the corresponding off-site advertising space groups; and
obtaining quality indicators of off-site advertising flows in the corresponding off-site advertising space groups by analyzing the results data of the off-site advertising space groups and regarding the indicators as the quality indicators of the advertising flows of the corresponding off-site advertising spaces.

5. The method as described in claim 2, wherein the obtaining of the analytically and statistically derived on-site advertising flow quality indicators comprises:
collecting click log data and transaction log data on products or services advertised in on-site advertising spaces;
analyzing the click log data and the transaction log data to obtain results data for the on-site advertising spaces;
dividing the on-site advertising space results data into a plurality of corresponding on-site baseline groups based on advertising flow information;
pooling and averaging the results data for the on-site advertising spaces to obtain results data for the corresponding on-site baseline groups; and
obtaining quality indicators of the analytically and statistically derived on-site advertising flows by analyzing and statistically compiling the results data for the on-site baseline groups.

6. The method as described in claim 1, wherein the click log data and the transaction log data are click log data and transaction log data over a period of time.

7. The method as described in claim 1:
wherein the results data is retention rate, close rate, return on investment, or any combination thereof; and
wherein the close rate is a ratio of number of concluded deals to attention level of product categories, the retention rate is a ratio of number of operations following visits to number of visits, and the return on investment is a ratio of concluded deal monetary benefit to inputs.

8. The method as described in claim 7:
wherein in the event that the results data includes a plurality of types of results data, the quality indicators of the advertising flows of the off-site advertising spaces includes the quality indicators of the off-site advertising flows of various types of results data; and
wherein the obtaining flow quality comparison parameters for the off-site advertising spaces based on the quality indicators of the advertising flows of the off-site advertising spaces comprises:
obtaining flow quality comparison parameters for the various types of results data on the relevant off-site advertising spaces based on the quality indicators of the off-site advertising flows of the various types of results data; and
calculating weighted averages of the flow quality comparison parameters for the various types of results data and obtaining flow quality comparison parameters for the relevant off-site advertising spaces based on weights of the various types of the results data.

9. The method as described in claim 7:
wherein in the event that an advertising flow information comprises the product categories, the quality indicators of the advertising flows of the off-site advertising spaces comprise quality indicators of the off-site advertising flows corresponding to various product categories;
wherein the obtaining of the flow quality comparison parameters for the off-site advertising spaces based on the quality indicators of the advertising flows of the off-site advertising spaces comprises:
obtaining flow quality comparison parameters for the various product categories of the relevant off-site advertising spaces based on the quality indicators of off-site advertising flows corresponding to the various product categories; and
calculating weighted averages of the flow quality comparison parameters for the various product categories and obtaining flow quality comparison parameters for the corresponding off-site advertising spaces based on weights for the various product categories; and
wherein the weights of product categories are the ratios of the off-site advertising flows of the product categories to the off-site advertising flows of all product categories.

10. The method as described in claim 1, wherein the obtaining of the flow quality comparison parameters for the off-site advertising spaces based on the quality indicators of the advertising flows of the off-site advertising spaces comprises:
calculating weighted moving averages of daily results data of the off-site advertising spaces over a period of time,
wherein the weights of the daily results data of the off-site advertising spaces over the period of time decrease linearly or exponentially with time; and
wherein a most recent weight is greater than a next most recent weight.

11. A method of recommending off-site advertising spaces, comprising:
generating flow quality comparison parameters, wherein the generating of the flow quality comparison parameters comprises:
collecting click log data and transaction log data on relevant products or services advertised in off-site advertising spaces;
generating off-site advertising space results data based at least in part on the click log data and the transaction log data;
obtaining quality indicators of advertising flows of the corresponding off-site advertising spaces based on the off-site advertising space results data; and
obtaining flow quality comparison parameters for the off-site advertising spaces based at least in part on the quality indicators of the advertising flows of the off-site advertising spaces, the flow quality comparison parameters relating to a comparison of off-site advertising prices to on-site advertising prices;
ranking off-site advertising spaces according to the flow quality comparison parameters in large to small order; and
displaying the ranked off-site advertising spaces in the event that advertising is carried out through an advertising server.

12. A system for generating flow quality comparison parameters, comprising:
at least one processor configured to:
collect click log data and transaction log data on relevant products or services advertised in off-site advertising spaces;
generate off-site advertising space results data based at least in part on the click log data and the transaction log data;
obtain quality indicators of the advertising flows of the corresponding off-site advertising spaces based on the off-site advertising space results data; and
obtain flow quality comparison parameters for the off-site advertising spaces based at least in part on the quality indicators of advertising flows of the off-site advertising spaces, the flow quality comparison parameters relating to a comparison of off-site advertising prices to on-site advertising prices; and
a memory coupled to the at least one processor and configured to provide the at least one processor with instructions.

13. A system for recommending off-site advertising spaces, comprising:
at least one processor configured to:
generate flow quality comparison parameters, wherein the generating of the flow to quality comparison parameters comprises:
collect click log data and transaction log data on relevant products or services advertised in off-site advertising spaces;
generate off-site advertising space results data based at least in part on the click log data and the transaction log data;
obtain quality indicators of advertising flows of the corresponding off-site advertising spaces based on the off-site advertising space results data; and
obtain flow quality comparison parameters for the off-site advertising spaces based at least in part on the quality indicators of the advertising flows of the off-site advertising spaces, the flow quality comparison parameters relating to a comparison of off-site advertising prices to on-site advertising prices;
rank off-site advertising spaces according to the flow quality comparison parameters in large to small order; and
display the ranked off-site advertising spaces in the event that advertising is carried out through an advertising server; and
a memory coupled to the at least one processor and configured to provide the at least one processor with instructions.

14. An advertisement billing method, comprising:
generating flow quality comparison parameters, wherein the generating of the flow quality comparison parameters comprises:
collecting click log data and transaction log data on relevant products or services advertised in off-site advertising spaces;
generating off-site advertising space results data based at least in part on the click log data and the transaction log data;
obtaining quality indicators of advertising flows of the corresponding off-site advertising spaces based on the off-site advertising space results data; and
obtaining flow quality comparison parameters for the off-site advertising spaces based at least in part on the quality indicators of the advertising flows of the off-site advertising spaces, the flow quality comparison parameters relating to a comparison of off-site advertising prices to on-site advertising prices;
acquiring advertising space identifying information and advertiser information based on click log data and transaction log data on products or services; and
billing relevant advertisers according to the flow quality comparison parameters for the off-site advertising spaces in the event that the advertising space identifying information is for off-site advertising space.

15. An advertisement billing system, comprising:
at least one processor configured to:
generate flow quality comparison parameters, wherein the generating of the flow quality comparison parameters comprises:
collect click log data and transaction log data on relevant products or services advertised in off-site advertising spaces;
generate off-site advertising space results data based at least in part on the click log data and the transaction log data;
obtain quality indicators of advertising flows of the corresponding off-site advertising spaces based on the off-site advertising space results data; and
obtain flow quality comparison parameters for the off-site advertising spaces based at least in part on the quality indicators of the advertising flows of the off-site advertising spaces, the flow quality comparison parameters relating to a comparison of off-site advertising prices to on-site advertising prices;
acquire advertising space identifying information and advertiser information based on click log data and transaction log data on products or services; and
bill relevant advertisers according to flow quality comparison parameters for the off-site advertising spaces in the event that the advertising space identifying information is for off-site advertising space; and
a memory coupled to the at least one processor and configured to provide the at least one processor with instructions.

16. A computer program product for generating flow quality comparison parameters, the computer program product being embodied in a non-transitory computer readable storage medium and comprising computer instructions for:
collecting click log data and transaction log data on relevant products or services advertised in off-site advertising spaces;
generating off-site advertising space results data based at least in part on the click log data and the transaction log data;
obtaining quality indicators of advertising flows of the corresponding off-site advertising spaces based on the off-site advertising space results data; and
obtaining flow quality comparison parameters for the off-site advertising spaces based at least in part on the quality indicators of the advertising flows of the off-site advertising spaces, the flow quality comparison parameters relating to a comparison of off-site advertising prices to on-site advertising prices.
